(19) United States
(12) Patent Application Publication
(10) Pub. No.: US 2004/0130685 A1
(43) Pub. Date: Jul. 8, 2004

(54) Automatic focusing method for projector and projector using this method

(75) Inventor: Chung-Wei Wu, Taipei (TW)

Correspondence Address: BACON & THOMAS, PLLC, 625 SLATERS LANE, FOURTH FLOOR, ALEXANDRIA, VA, 22314

(73) Assignee: LITE-ON TECHNOLOGY CORPORATION, Taipei (TW)

(21) Appl. No.: 10/446,096

(22) Filed: May 28, 2003

(30) Foreign Application Priority Data
Jan. 2, 2003 (TW) 092100022

(51) Int. Cl. G03B 21/14

(52) U.S. Cl. 353/101

(57) ABSTRACT

An automatic focusing projector comprises a rangefinder, microprocessor, stepping motor and zoom lens. The rangefinder is used to measure a distance between the projector and a projection screen. The table look-up method is used to obtain a position that the stepping motor should be rotated after the microprocessor read the distance. And then, the stepping motor is commanded to drive the zoom lens to the position. Thereby, the automatic focusing method can be performed on a projector device.

### BACKGROUND OF THE INVENTION

1. Field of the Invention

The present invention relates to an automatic focusing method for a projector and a projector using this method, and more particularly to an automatic focusing method for a projector with a rangefinder.

2. Description of Related Art

A projector must always be re-located, when it is in use. Once it is moved, a focal distance thereof must be re-adjusted. But obviously, such kind of manual adjustment is very troublesome and energy wasting.

### SUMMARY OF THE INVENTION

The main object of the present invention is to provide an automatic focusing method for a projector and a projector using this method, a rangefinder is provided to measure the distance between a projector and a screen, and a stepping motor is used to drive a lens to attain the automatic focusing according to the measured distance.

Another object of the present invention is to provide an automatic focusing method for a projector and a projector using this method, an automatic focusing rangefinder elements used in the present invention is a very matured product, the price thereof is low, the added value of a projector product gets higher if such kind of rangefinder is used therein.

### BRIEF DESCRIPTION OF THE DRAWINGS

The present invention can be more fully understood by reference to the following description and accompanying drawings, in which:

FIG. 1 is a block diagram, showing a structure of an automatic focusing projector according to the present invention; and

FIG. 2 is a flow chart, showing an automatic focusing procedure for a projector according to the present invention.

### DETAILED DESCRIPTION OF THE PREFERRED EMBODIMENTS

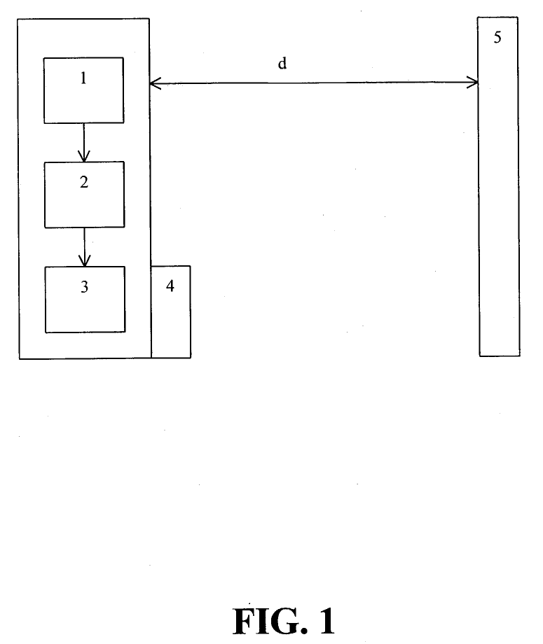

Please refer to FIG. 1. FIG. 1 is a block diagram, showing a structure of an automatic focusing projector according to the present invention. A projector according to the present invention can be a traditional optical reflection type projector or LCD projector, it comprises a rangefinder 1 used to measure the distance between the project and a screen 5 and chosen from an auto focus (AF) rangefinder element of a camera product such as VAF (Vistronic Automatic Focusing) system used in Konica camera, FCM (Focus Control Module) system used in Olympus camera or SST (Solid State Triangulation) system used in Cannon camera; a stepping motor 3 used to drive a zoom lens 4 to adjust the clearness of images; a microprocessor 2 used to read the distance d measured by the rangefinder 1, to obtain a position that the stepping motor should be rotated through table look-up method, and then to control the stepping motor 3 to rotate the zoom lens 4 to the position to complete the automatic focusing.

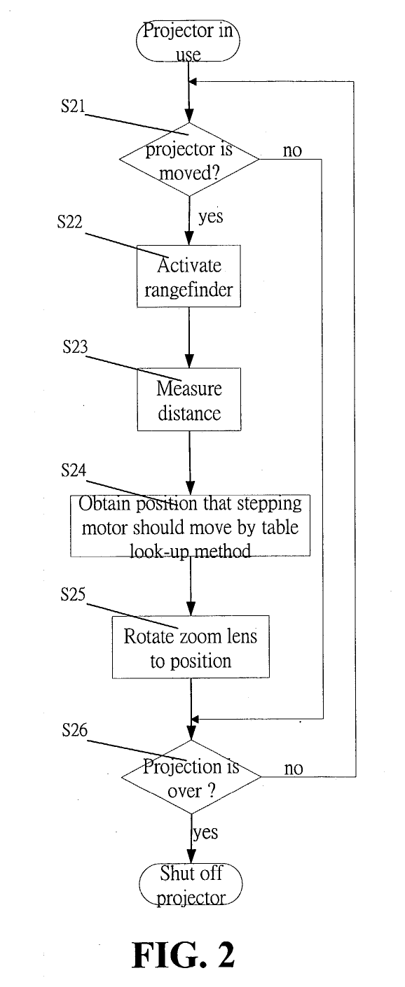

Next, please refer to FIG. 2. FIG. 2 is a flow chart, showing an automatic focusing procedure for a projector according to the present invention. First, a projector is used; check whether the projector is moved (step S21). If not, check directly whether projection is over (step S26), and please take the following description as a reference for the steps after the step S26. But, if the projector is moved, activate a rangefinder (step S23) to measure a distance between a projector and a screen. Taking the measured distance as a reference, allow a microprocessor to obtain a position that a stepping motor should be rotated through a table look-up method (step S24). Next, the microprocessor controls the stepping motor to rotate a zoom lens to the position (step S25). Furthermore, check whether the projection is over (step S26). If yes, turn off the projector. If not, continue the flow of the automatic focusing.

It is noted that the automatic focusing method for a projector and a projector using this method described above is the preferred embodiment of the present invention for the purpose of illustration only, and are not intended as a definition of the limits and scope of the invention disclosed. Any modifications and variations that may be apparent to a person skilled in the art are intended to be included within the scope of the present invention.

What is claimed is:

1. An automatic focusing method for a projector, mainly comprising the following steps:
(1) measuring a distance between a projector and a screen by a rangefinder;
(2) reading said distance by a microprocessor;
(3) obtaining a position that a stepping motor should be rotated through a table look-up method;
(4) driving a zoom lens to rotate to said position by said steeping motor to complete an automatic focusing.

2. The method according to claim 1, an auto focus rangefinder element of a camera can be used for said rangefinder.

3. An automatic focusing projector, mainly comprising a rangefinder, microprocessor, stepping motor and zoom lens; wherein said rangefinder is used for measuring a distance between said projector and a screen, said microprocessor obtains a distance that said stepping motor should rotate through a table look-up method after reading said distance, said stepping motor drives said zoom lens to rotate to said position.

4. The projector according to claim 3, an auto focus rangefinder element of a camera can be used for said rangefinder.
